(19) United States
(12) Patent Application Publication
(10) Pub. No.: US 2015/0060641 A1
(43) Pub. Date: Mar. 5, 2015

(54) OPTICAL TOUCH DEVICE

(71) Applicant: CORETRONIC CORPORATION, HSIN-CHU (TW)

(72) Inventors: YUNG-CHIH CHEN, Hsin-Chu (TW); CHUNG-LUNG YANG, Hsin-Chu (TW); LEI-CHIH CHANG, Hsin-Chu (TW)

(21) Appl. No.: 14/326,603

(22) Filed: Jul. 9, 2014

(30) Foreign Application Priority Data
Sep. 4, 2013 (CN) 201310397310.7

(51) Int. Cl. G06F 3/042

(52) U.S. Cl. CPC G06F 3/0421
USPC 250/206.1

(57) ABSTRACT

An optical touch device defining a sensing area includes two scanning modules and a light detecting element. The scanning modules respectively disposed on terminals of a first side of the sensing area include light-emitting elements and reflective elements. The light-emitting element is used for emitting a detective light along a first pathway and the reflective element has a reflective surface for reflecting the detective light such that the detective light is emitted along a second pathway. There is an angle forming between the first side and the second pathway and the reflective surface changes a direction of the second pathway such that the detective light scans in the sensing area. The detective light has a first intensity and a second intensity, in which the first intensity is less than the second intensity. The light detecting element is used for receiving a detective light reflected by an object.

### FIELD OF THE INVENTION

The invention relates to a touch device, and more particularly to an optical touch device.

### BACKGROUND OF THE INVENTION

Recently, touch technology is largely applied into several kinds of electronic devices such as personal computers, industrial computers, tablets, mobile phones or large-scale electronic whiteboards, etc. Each of the electronic devices has a touch panel for a user to send control messages to the electronic devices, or draw or write on the touch panel by using a finger or a touching pen. In order to identify what are the control messages at the points touched by the finger or the touching pen, respectively, it is important to correctly detect the locations of the touched points on the touch panels nowadays.

At present, the touch technology can be classified into a resistive touch technology, a capacitive touch technology, and an optical touch technology. The optical touch technology can be further classified into, for example, an optical scanning type and other types. In an optical scanning type touch device, two rotatable reflective mirrors are used to respectively reflect the laser light for scanning an object on the touch panel. Furthermore, the time point the light detecting element received the laser light reflected from the object is recorded to confirm the angle that the rotatable reflective mirror has been rotated, thereby defining the coordinate position of the object on the touch panel.

However, the intensity of the laser reflected by the object may overload to result in a judging error of the time point when the object to be detected is close to one of the light detecting devices, and thus the location of the object on the touch panel may not be correctly defined. On the other hand, a low power laser may solve the overloading problem, but the intensity of the laser reflected by the object may be insufficient when the object to be detected is far from one of the light detecting devices. Therefore, the judging error of the time point owing to one of the light detecting devices disturbed by the noise may cause the location of the object on the touch panel may not be correctly defined.

### SUMMARY OF THE INVENTION

The invention provides an optical touch device for precisely sensing a location of an object.

According to an embodiment of the invention, an optical touch device defines a sensing area, and includes two scanning modules and a light detecting element. The two scanning modules are respectively disposed on two terminals of a first side of the sensing area. Each of the scanning modules includes a light-emitting element and a reflective element. Each of the light-emitting elements is used for emitting a detective light along a first pathway. Each of the reflective elements has a reflective surface for reflecting the detective light such that the detective light is emitted along a second pathway. There is an angle formed between the first side and the second pathway and the reflective surface is configured to be rotated in a determined angle range for changing a direction of the second pathway such that the detective light scans the sensing area, the determined angle range includes a first preset range and a second preset range, the detective light has a first intensity when a value of the angle is under the first preset range, and the detective light has a second intensity when the value of the angle is under the second preset range, in which the first intensity is less than the second intensity and any one value of the first preset range is less than any one value of the second preset range. The light detecting element is disposed beside the first side of the sensing area and located between the two scanning modules for receiving a reflected light reflected by an object located in the sensing area.

According to another embodiment disclosed herein, the optical touch device further includes a carrier board for carrying the scanning modules and the light detecting element.

According to another embodiment disclosed herein, the light-emitting element of the scanning module is located between a corresponding reflective surface and the light detecting element.

According to another embodiment disclosed herein, the optical touch device further includes a critical angle that divides the first preset range from the second preset range, and the critical angle is the largest angle formed between the first side and the detective light reflected by the reflective surface in the first preset range.

According to another embodiment disclosed herein, the determined angle range further includes a third preset range, and the detective light has a third intensity when the value of the angle is under the third preset range, the third intensity is less than the second intensity, and any one value of the second preset range is less than any one value of the third preset range.

According to another embodiment disclosed herein, a scanning speed of the detective light in the second preset range is larger than a scanning speed of the detective light in the third preset range.

According to another embodiment disclosed herein, each of the scanning modules further includes a light detector, each of the light detectors is disposed on a second side of the sensing area, and the second side is connected to the first side.

According to another embodiment disclosed herein, each of the scanning modules includes a base, and the light detectors, the reflective elements, and the light-emitting elements are respectively disposed on the bases.

According to another embodiment disclosed herein, the light detecting element is located between the bases.

According to another embodiment disclosed herein, each of the light-emitting elements is a power-adjustable light-emitting element for changing an intensity of the detective light.

The optical touch device of the invention can adjust the intensity of the detective light according to the range of the scanning area such that the light detecting element can receive the detective light having suitable intensity when the object is far from the light detecting element or close to the light detecting element. Thus, the optical touch device can correctly detect the location of the object, wherein the intensity of the reflected light received by the light detecting element corresponds to the intensity of the detective light.

### BRIEF DESCRIPTION OF THE DRAWINGS

The invention will become more readily apparent to those ordinarily skilled in the art after reviewing the following detailed description and accompanying drawings, in which:

FIG. 1 illustrates a top view of an optical touch device according to an embodiment of the invention;

FIG. 2 illustrates a magnified drawing of an A part of the optical touch device shown in FIG. 1; and

FIG. 3 illustrates a partial top view of an optical touch device according to another embodiment of the invention.

### DETAILED DESCRIPTION OF PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

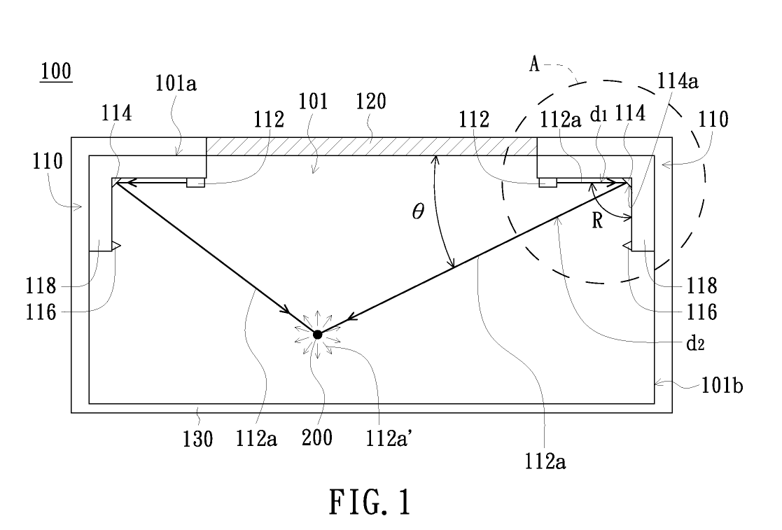

FIG. 1 shows a top view of an optical touch device 100 according to an embodiment of the invention. As shown in FIG. 1, the optical touch device 100 defines a sensing area 101, for example, the shape of the sensing area may be, but not limited to, rectangle, etc. The shape/location of the sensing area can be altered according to actual design requirement. The optical touch device includes two scanning modules 110 and a light detecting element 120. When a detective light 112a emitted by the scanning modules 110 is reflected by an object 200 in the sensing area 101, the detective light being reflected by the object 200 is defined as a reflected light 112a′ as shown in FIG. 1. The reflected light 112a′ will be received by the light detecting element 120. In this embodiment, the optical touch device 100 further includes a carrier board 130 for carrying the scanning modules 110 and the light detecting element 120. For example, the carrier board 130 may be, but not limited to, a display panel or a panel that does not have a display function (e.g., a glass panel, a plastic panel, etc.). Moreover, the object 200 may be, but not limited to, a finger of a user, a touch pen or any object able to reflect the detective light 112a.

The two scanning modules 110 are respectively disposed on two terminals of a first side 101a of the sensing area 101, in which the two terminals are opposite to each other. Each of the scanning modules 110 includes a light-emitting element 112 and a reflective element 114. The light-emitting element 112 is used for emitting the detective light 112a along a first pathway d₁, in which the first pathway d₁ may be parallel to the first side 101a. In this embodiment, each of the light-emitting elements 112 is located between the light detecting element 120 and the reflective elements 114. The light-emitting elements 112 is a power-adjustable light-emitting element for changing an intensity of the detective light 112a, and how to change the intensity of the detective light 112a emitted by the light-emitting elements 112 should not be limited. In addition, the detective light 112a may be, but not limited to, a laser. Furthermore, the detective light 112a may be, but not limited to, an infrared laser. On the other hand, the reflective element 114 has a reflective surface 114a for reflecting the detective light 112a emitted by the light-emitting element 112 such that the detective light 112a is emitted along a second pathway d₂. In this embodiment, the light-emitting elements 112 has an emitting surface, and the emitting surface faces to the reflective surface 114a such that the detective light 112a emitted by the light-emitting elements 112 may be transmitted to the reflective surface 114a along the first pathways d₁ and transmitted along one of the second pathways d₂ after being reflected by the reflective surfaces 114a. There is an angle θ formed between the first side 101a and the second pathway d₂. In addition, the reflective surface 114a is configured to be rotated in a determined angle range for changing a direction of the second pathway d₂ such that the detective light 112a scans the sensing area 101 along the different second pathway d₂. In other words, the reflective surface 114a is rotated in the determined angle range such that the angle θ formed between the first side 101a and the second pathway d₂ may be changed. Thus, an emitted direction of the detective light 112a may be changed such that the detective light 112a scans the sensing area 101 in the determined angle range R. In this embodiment, the reflective element 114 may be, but not limited to, micro-electronic-mechanic system (MEMS) oscillatory reflectors. In an ideal embodiment, the reflective surface 114a may be rotated in the determined angle range R about 90° (may be shown as −45°˜45° such that the range of the angle θ formed between the first side 101a and the second pathway d₂ may be 0°˜90° such that the detective light 112a scans all sensing area 101 under the determined angle range R. In practice, the rotatable angle of the reflective surface 114a may not be exactly 90° because of several factors. In this case, adjusting the setting angle of the reflective surface 114a to fine-tune the angle θ can make the range of the angle θ formed between the first side 101a and the second pathway d₂ to be 0°˜90°.

In addition, each of the scanning modules 110 includes a light detector 116, the light detector 116 is, but not limited to, disposed on a second side 101b of the sensing area 101, in which the second side 101b is connected to the first side 101a and the second side 101b is perpendicular to the first side 101a. However, the light detector 116 and the light-emitting element 112 may be, but not limited to, disposed on the second side 101b of the sensing area 101. In another embodiment, the position of the light detector 116 and the light emitting element 112 are interchangeable. In this embodiment, the light detector 116 may, for example, detect the detective light 112a when the angle θ is 90°. Therefore, the angle variation value of the angle θ can be calculated by recording two time points that the light detector 116 continuously receives the detective light 112a. Then, a database of the values of the angle θ in every time point can be constructed. Thus, the light detecting elements 120 can determine the angle variation value of the angle θ according to the database when the light detecting elements 120 detect the location of the object 200. In detail, a formula showing the value of the angle θ is as follows:

θ=90−45*(1−COS(2πft))*A/90+B

in which f is the frequency of the light detector 116 continuously receiving the detective light 112a for two times, t is the time the reflective face 114a being rotated, A is the angle range that the reflective surface 114a is actually rotated, and B is the tuning value of the disposing angle of the reflective surface 114a.

It should be understood that the light detectors 116 may not be disposed when the rotating angle of the reflective element 114 has already been known. In this embodiment, each of the scanning modules 110 may, but not be limited to, include a base 118, and the light detectors 116, the reflective elements 114 and the light-emitting elements 112 are respectively disposed on the bases 118, and light detecting elements 120 are connected between the bases 118.

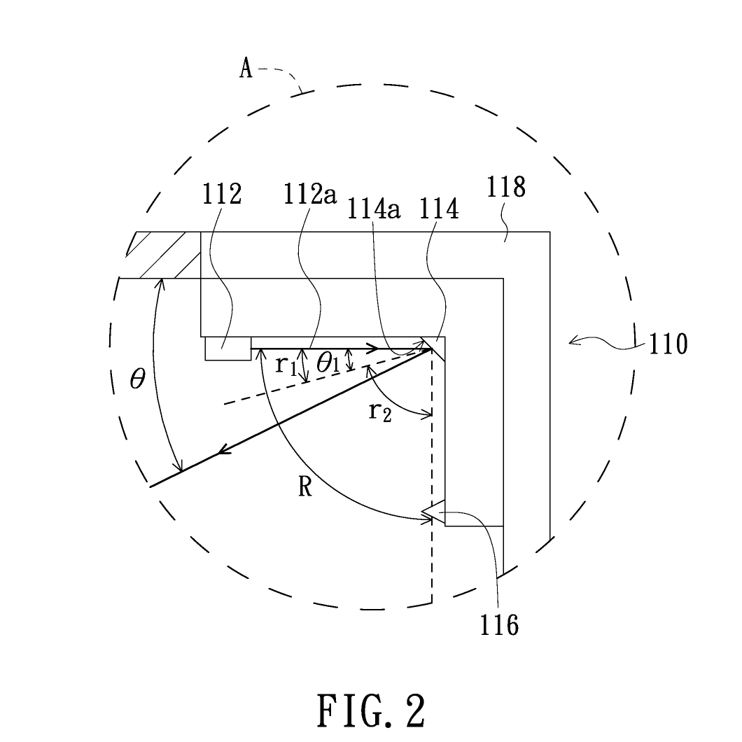

FIG. 2 shows a magnified drawing of a part of the optical touch device A shown in FIG. 1. As shown in FIG. 1 and FIG. 2, the determined angle range R includes the first preset range r₁ and the second preset range r₂. In this embodiment, the scanning module 110 of the optical touch device 100 further may, but be not limited to, include a critical angle θ₁ that divides the first preset range r₁ from the second preset range r₂, in which a range of the critical angle is 10°˜15°. It should be understood that the critical angle θ₁ is the max value of the angle θ that is formed between the detecting light 112a reflected by the reflected surface 114a and the first side 101a in the first preset ranges r₁. That is to say, when the detective light 112a reflected by reflective surface 114a scans under the first preset range r₁, the light power of light-emitting element 112 can be adjusted so as to emit the detective light 112a having the second intensity. For example, when the light power of the light-emitting element 112 is, but not limited to, 45 mW, the light-emitting element 112 may emit the detective light 112a having the first intensity. On the other hand, the detective light 112a has a second intensity when the detective light 112a is reflected by reflective surface 114a such that a value of the angle θ is under the second preset range r₂, in which the first intensity is less than the second intensity. That is to say, when the detective light 112a scans under the second preset range r₂, the light power of light-emitting element 112 can be adjusted so as to emit the detective light 112a having the second intensity. For example, when the light power of the light-emitting element 112 is, but not limited to, 150 mW, the light-emitting element 112 may emit the detective light 112a having the second intensity. In this embodiment, a scan area formed by the detective light 112a scanning under the first preset range r₁ is closer to the light detector 120 than a scan area formed by the detective light 112a scanning under the second preset range r₂. That is, the value of the angle θ under the first preset range r₁ is less than the value of the angle θ under the second preset range r₂. In this embodiment, any one value of the first preset range r₁ is less than any one value of the second preset range r₂. Accordingly, the value of angle θ formed by the detective light 112a reflected by the reflective surface 114a under the first preset range r₁ is less than the value of angle θ under the second preset range r₂. Besides, the method of adjusting intensity of detective light 112a is not just for changing the power of the light emitting element 112. In another embodiment, a light energy attenuator (not shown) may be disposed on the pathway of the detective light 112a under the first preset range r₁ such that the intensity of the detective light 112a under the first preset range r₁ is less than the intensity of the detective light 112a under the second preset range r₂.

Referring to FIG. 1 again, the light detecting element 120 of the optical touch device 100 is disposed beside the first side 101a of the sensing area 101 and located between the two scanning modules 110 for receiving the reflected light 112a′ reflected by the object 200 located in the sensing area 101. In other words, when the object 200 is located on the sensing area 101 and the detective light 112a meets the object 200 along the second pathway d₂, the detective light 112a will be scattered to form the reflected light 112a′. Then, the light detecting element 120 can receive part of the reflected light 112a′ toward the light detecting element 120. Next, the time points of the reflected light 112a′ received are analyzed, and thus the value of the angle θ can be obtained. After the value of the angle θ is obtained, the optical touch device 100 may use the triangle localization method to calculate the location of the object, in which the optical touch device 100 may have an internal processing element to calculate the location of the object 200.

In this embodiment, the optical touch device 100 may adjust the intensity of the detective light 112a according to the different preset ranges of the sensing area 101 such that the light detective elements 120 may receive the suitable intensity of the reflected light 112a′ to correctly detect the location of the object 200 when the object is close to the light detective element 120 or far from the light detective element 120. In addition, the intensity of the detective light 112a can be changed by changing the light power of the light-emitting element 112 according to the time period because the time period of the detective light 112a is fixed in the first preset range r₁ and the second preset range r₂.

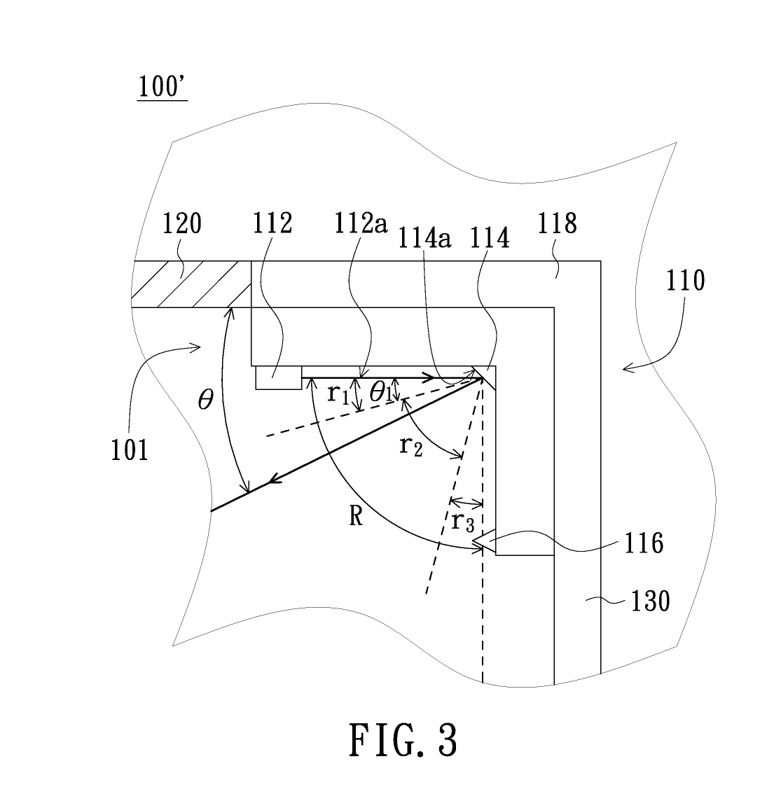

FIG. 3 shows a partial top view of an optical touch device 100′ according to another embodiment of the invention. As shown in FIG. 3, the optical touch device 100′ is similar to the optical touch device 100 shown in FIG. 1, but the difference is the determined angle R in this embodiment includes a first preset range r₁, a second preset range r₂, and a third preset range r₃, in which any one value of the second preset range r₂ is less than any one value of the third preset range r₃. Accordingly, the value of angle θ formed by the detective light 112a reflected by the reflective surface 114a under the second preset range r₂ is less than the value of angle θ under the third preset range r₃. In this embodiment, a scan area formed by the detective light 112a scanning under the third preset range r₃ is closer to the light detector 120 than a scan area formed by the detective light 112a scanning under the second preset range r₂. When the reflective surface 114 is rotated to a max angle (e.g. +45° or −45°, the reflective surface 114a will then be rotated to a reverse direction, and thus the rotating speed of the reflective surface 114a will become slow and so the scanning speed of the detective light 112 will become slow. The third preset range r₃ is the range that the scanning speed of the detective light 112a becomes slow. That is, the scanning speed of the detective light 112a under the second preset range r₂ is larger than the scanning speed of the detective light 112a under the third preset range r₃. The reflected light 112a′ may stay on the same position of the light detecting element 120 (referring to FIG. 1) for a longer time because the scanning speed becomes slow, the light detecting element 120 may receive more energy. In order to meet the safety requirement, the detective light 112a has a third intensity, in which the third intensity is less than the second intensity when the value of the angle θ is under the third preset range r₃. In this embodiment, the third preset range r₃ is 80°˜90°. In other words, when the angle θ is 80°˜90°, the detective light 112a has the third intensity that is, but not limited to, less than the second intensity. The third intensity can be equal to the first intensity, or can be larger or less than the first intensity. In addition, the way of adjusting the intensity of the detecting light 112a is similar to the foregoing and will not be further described.

The optical touch device can adjust the intensity of the detective light according to the range of the scanning area such that the light detecting element can receive the detective light having suitable intensity when the object is far from the light detecting element or close to the light detecting element, and thus the optical touch device can correctly detect the location of the object. In addition, the power of the detective light can be decreased such that the optical touch device meets the safety requirement in the range that the reflective surface is rotated slowly.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. An optical touch device defining a sensing area, and the optical touch device comprising:
two scanning modules respectively disposed on two terminals of a first side of the sensing area, and each of the scanning modules comprising:
a light-emitting element for emitting a detective light along a first pathway; and
a reflective element having a reflective surface for reflecting the detective light such that the detective light is emitted along a second pathway, there is an angle formed between the first side and the second pathway, the reflective surface is configured to be rotated in determined angle range for changing a direction of the second pathway such that the detective light scans the sensing area, wherein the determined angle range includes a first preset range and a second preset range, the detective light has a first intensity when a value of the angle is under the first preset range, the detective light has a second intensity when the value of the angle is under the second preset range, the first intensity is less than the second intensity, and any one value of the first preset range is less than any one value of the second preset range; and
a light detecting element disposed beside the first side of the sensing area and located between the scanning modules for receiving a reflected light reflected by an object located in the sensing area.

2. The optical touch device according to claim 1, further comprising a carrier board for carrying the scanning modules and the light detecting element.

3. The optical touch device according to claim 1, wherein the light-emitting element of each scanning module is located between a corresponding reflective surface and the light detecting element.

4. The optical touch device according to claim 1, further comprising a critical angle that divides the first preset range from the second preset range, and the critical angle being the largest angle formed between the first side and the detective light reflected by the reflective surface in the first preset range.

5. The optical touch device according to claim 1, wherein the determined angle range further comprises a third preset range and the detective light has a third intensity when the value of the angle is under the third preset range, the second intensity is greater than the third intensity, and any one value of the second preset range is less than any one value of the third preset range.

6. The optical touch device according to claim 5, wherein a scanning speed of the detective light in the second preset range is larger than a scanning speed of the detective light in the third preset range.

7. The optical touch device according to claim 1, wherein each of the scanning modules further comprises a light detector, disposed on a second side of the sensing area, and the second side is connected to the first side.

8. The optical touch device according to claim 7, wherein each of the scanning modules further comprises a base, and the light detectors, the reflective elements, and the light-emitting elements are respectively disposed on the bases.

9. The optical touch device according to claim 8, wherein the light detecting element is located between the bases.

10. The optical touch device according to claim 1, wherein each of the light-emitting elements is a power-adjustable light-emitting element for changing an intensity of the detective light.
